(19) United States
(12) Patent Application Publication
(10) Pub. No.: US 2026/0244474 A1
(43) Pub. Date: Aug. 20, 2026

(54) AUTOMATED SERVICE FRAMEWORK FOR CLOUD ENVIRONMENTS

(71) Applicant: REGDESK, Inc., Houston, TX (US)

(72) Inventors: Jixian WANG, Odessa (UA); HaiBiao Deng, Guangdong (CN)

(21) Appl. No.: 19/064,507

(22) Filed: Feb. 26, 2025

(30) Foreign Application Priority Data
Feb. 18, 2025 (CN) 202510174589.5

(51) Int. Cl. G06F 9/455

(52) U.S. Cl. CPC G06F 9/45508; G06F 9/45558; G06F 2009/45562; G06F 2009/45595

(57) ABSTRACT

Systems, methods, and devices for automating data processing tasks that typically rely on specialized software without API-level access. A virtual machine environment may be created on a cloud server for automated interaction with a target software application. Configuration instructions specifying one or more automation tasks for execution within the virtual machine environment may be received. Automation tasks may be executed within the virtual machine environment by emulating user interactions with the target software application. Data generated by the target software application may be received in response to the emulated user interactions and an execution status associated with the one or more automation tasks may be determined based on the received data. The execution status may be transmitted to a designated external system.

### CROSS-REFERENCE TO RELATED APPLICATIONS

This application claims the benefit of, and priority to, Chinese Patent Application No. 202510174589.5, filed Feb. 18, 2025, and entitled “AUTOMATED SERVICE FRAMEWORK FOR CLOUD ENVIRONMENTS,” the disclosure of which is incorporated by reference in its entirety as if the same was fully set forth herein.

### TECHNICAL FIELD

The present disclosure generally relates to automated service frameworks in cloud computing environments, and more particularly to facilitating automation of data processing tasks that typically rely on specialized software without API-level access. According to some aspects, the present disclosure pertains to systems and methods for creating virtual machine environments on cloud servers to support and automate software interactions.

### BACKGROUND

In cloud computing environments, automated workflows are increasingly critical for managing data processing tasks across diverse applications. However, a significant challenge in automating these workflows arises from specialized software programs that lack application program interface (API)-level access or do not integrate seamlessly with cloud-native systems. Many legacy applications and certain specialized programs, such as advanced document management software or industrial control systems, were not designed for integration into automated or cloud-based architectures. These systems often rely on direct user interactions with graphical interfaces (UIs) to perform essential tasks, making them difficult to integrate into fully automated workflows.

For example, some advanced features in desktop software like Adobe Acrobat Pro, including document signing and merging, do not provide API-level access. Similarly, industrial control and device management software often depend on proprietary drivers and user interfaces unique to PC-based systems, further complicating integration with cloud automation frameworks. In traditional automation approaches, these tasks typically necessitate manual intervention, as they require operations that cannot be programmatically triggered within existing software infrastructures.

With the shift towards cloud environments, organizations seek methods to automate these processes without extensive software modifications or the need for workarounds that compromise system reliability. Current automation methods have limitations, particularly in systems where licensing or proprietary software constraints restrict modification of the target software Accordingly, there is a need for an automated service framework that can replicate manual interactions with these software applications while maintaining compliance with licensing agreements and without altering the underlying software.

This background information is provided to reveal information believed by the applicant to be of possible relevance. No admission is necessarily intended, nor should be construed, that any of the preceding information constitutes prior art.

### SUMMARY

Briefly described, and in various embodiments, the present disclosure generally relates to an automated service framework for cloud environments, specifically addressing challenges associated with automating interactions with specialized software applications that lack direct API access or are otherwise difficult to integrate into cloud-based workflows. The disclosed automated service framework establishes virtual machine environments on cloud servers that host target software applications, enabling remote interactions with these applications through emulated user interface actions. Such automation facilitates tasks previously requiring manual operation, streamlining data processing workflows across diverse applications within cloud environments.

The present disclosure provides systems and methods for implementing non-intrusive automation of target software applications through simulated interactions with their user interfaces. The automated service framework may utilize one or more various techniques depending on the software architecture, such as using Object Linking and Embedding (OLE) for applications with native Windows UIs, WebDriverIO for web-based applications, and/or AI-powered image recognition for non-standard interfaces. Within each virtual machine environment, the disclosed system may capture UI elements or other interaction triggers, simulating human interactions, thereby automating complex tasks without modifying the target software. According to aspects of the disclosure, processing of tasks may be enabled in a manner that preserves software licensing compliance, maximizes reliability, and avoids reverse engineering or structural modification of the software.

Moreover, to optimize system performance and scalability, the automated service framework may employ one or more resource management techniques, where multiple virtual machines may handle simultaneous tasks queued within the system. Each virtual machine instance may operate independently, processing requests sequentially to ensure all tasks are executed accurately. Furthermore, the automated service framework may be equipped with a mechanism for real-time monitoring and reporting, allowing for asynchronous notifications of task completion statuses to designated external systems, thus enhancing system responsiveness and adaptability to varying workloads.

Advantages provided by the automated service framework may include reduced integration costs (e.g., by avoiding target software modification), increased software utilization by allowing cloud-based access, and enhanced system reliability by preserving the integrity of the software. Moreover, manual workflows may be transformed into automated, cloud-compatible operations, providing a robust and adaptable infrastructure for modern data processing needs in cloud environments.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE FIGURES

Reference will now be made to the accompanying drawings, which are not necessarily drawn to scale.

FIG. 1 illustrates an example of an automated service framework within a cloud environment;

FIG. 2 illustrates an exemplary process flow diagram;

FIG. 3 illustrates an exemplary process;

FIG. 4 illustrates a schematic of an exemplary device; and

FIG. 5 illustrates an exemplary diagrammatic representation of a machine in the form of a computer system.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

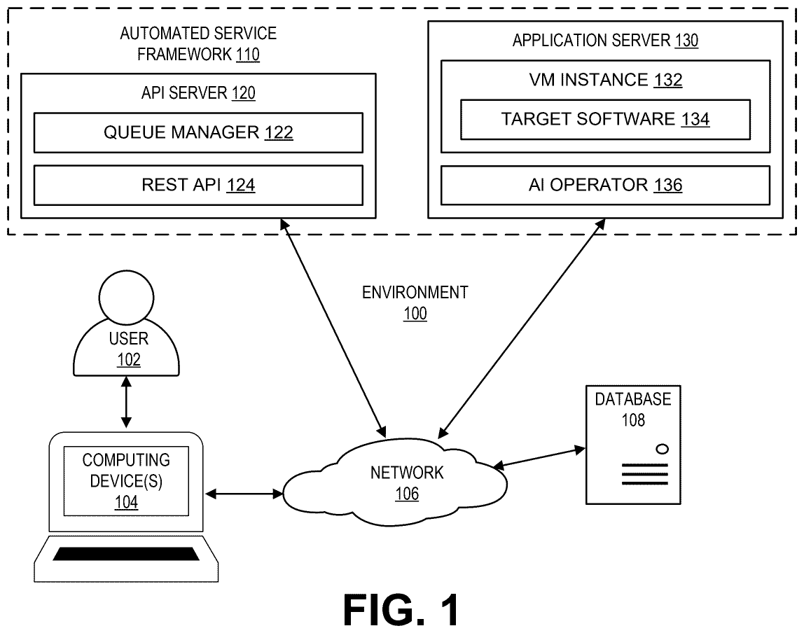

FIG. 1 illustrates an exemplary automated service framework 110 within an environment 100 (e.g., a cloud environment) to facilitate automation of software applications that lack direct API-level access. The environment 100 includes several interconnected components that work together to automate interactions with specialized target software applications. The components may be accessed by a user 102 via computing device(s) 104, connected over a network 106, to enable remote operation and management of tasks.

Moreover, the environment 100 may provide a scalable and secure platform where automated processes are executed, facilitating the automation of tasks across multiple software applications that otherwise lack integration capabilities. This environment 100 may further include a database 108, an API server 120, and/or an Application Server 130. By employing virtualization and/or load-balancing mechanisms, the environment 100 may allow virtual machine instances (VMs) to run independently and/or scale horizontally. The scalability may enable the environment 100 to process an increasing volume of automation tasks without compromising performance. For example, when several users initiate concurrent tasks, additional VMs may be instantiated dynamically to handle the load, effectively distributing processing resources as needed.

In addition to providing flexibility and scalability, the environment 100 may offer a secure ecosystem for automated interactions. Security protocols, such as encrypted connections and authentication methods, may be used to protect sensitive data exchanged within the environment 100, ensuring compliance with data protection standards. For example, the security protocols may be used when automating tasks that involve handling sensitive information, such as document management applications or regulated software systems in fields such as finance or healthcare.

The user 102 may interact with the automated service framework 110 via one or more computing device(s) 104, such as a desktop computer, laptop, or mobile device, which may act as a command center for issuing automation requests and monitoring task statuses. Through a web-based or standalone application interface, user 102 may submit detailed task requests, set task priorities, and/or define configurations for specific automation workflows. The computing device(s) 104 may connect to the environment 100 over the network 106, allowing user 102 to interact with the automated service framework 110 remotely, enhancing accessibility and flexibility for end-users.

In addition to initiating automation tasks, the computing device(s) 104 may provide real-time feedback to the user 102 on the status of ongoing tasks. For example, as an automation task progresses through various stages, such as task initiation, interaction with the target software, and completion, the computing device(s) 104 may display these updates within the user interface. Furthermore, the user interface may provide diagnostic information or troubleshooting insights if an issue arises during automation, allowing user 102 to make adjustments or resubmit tasks as needed.

The network 106 may connect the components of the environment 100. For example, the network 106 may include one or more internet and/or virtual private network (VPN) connections (e.g., for enhanced security) to facilitate seamless transfer of data, commands, and status updates between the components of the environment 100. For example, when user 102 submits an automation request from computing device(s) 104, the network 106 may ensure that the request reaches the API server 120 securely and promptly.

Moreover, the network 106 may support bidirectional communication, allowing the automated service framework 110 to relay real-time task status updates back to the computing device(s) 104. Furthermore, the network 106 may utilize one or more data compression and optimized routing protocols to minimize latency, ensuring high-performance data transfer within the cloud environment in cases where automation tasks involve processing large files or interacting with external databases.

The automated service framework 110 may include an API server 120, which may provide an interface for receiving automation requests from user 102 and/or external systems. The API server 120 may include a Queue Manager 122, which may prioritize and schedules tasks for efficient processing, ensuring each request is executed sequentially or according to specified priority levels. Moreover, the Queue Manager 122 may organize tasks based on specified parameters (e.g., scheduling parameters), such as task urgency, resource availability, and/or user-defined priorities. For example, tasks that are tagged as high-priority may be queued ahead of routine operations, ensuring critical processes are executed promptly.

According to some aspects, a user may specify that a data synchronization task should execute daily at midnight or that a batch processing task should run every hour. These scheduling parameters may be stored in a task queue managed by the API server 120 and executed accordingly within the environment 100. Moreover, the API server 120 may support conditional execution based on system or application states. For example, a task may be configured to execute only after certain prerequisites, such as the availability of updated data, are met. This flexibility provides efficient utilization of system resources and alignment with user-defined automation workflows.

Additionally, a REST API 124 may provide an interface for integrating with external systems, allowing other business processes to request and receive status updates on automation tasks. The REST API 124 may standardize communication with the automated service framework 110, allowing third-party applications or external systems to initiate tasks and retrieve statuses through HTTP requests. Moreover, the REST API 124 may be used to integrate the automated service framework 110 into existing enterprise systems, where automation tasks may be triggered directly from external software platforms, facilitating interoperability and centralized task management.

The automated service framework 110 may include an Application Server 130, which may host Virtual Machine (VM) instances 132 that run the target software 134. For example, the VM instances 132 may provide isolated environments for executing tasks on the target software 134, emulating human interactions. Within each VM instance 132, an AI operator 136 may interpret and execute the commands necessary to complete the task. For example, the AI operator 136 may leverage various techniques, including Object Linking and Embedding (OLE) for Windows-based applications, WebDriverIO for web-based interfaces, and optical character recognition (OCR) combined with Yolo AI-based image recognition for software with non-standard UIs, to control the UI elements within the target software 134.

According to some aspects, each VM instance 132 may operate in isolation, allowing the VM instance 132 to execute automation tasks independently of other instances. This isolated environment may be beneficial when multiple instances are required to process concurrent tasks on different software applications. The Application Server 130 may dynamically scale the VM instances 132 based on workload, optimizing resource usage by provisioning or decommissioning VM instances 132 as needed.

Moreover, the Application Server 130 may provide each VM instance with a controlled environment in which the target software 134 is deployed. For example, when a task is initiated, a VM instance may be created that loads the target software, configures the necessary environment settings, and/or triggers the AI operator 136 to begin the automation task. This setup may allow all automation tasks to be processed in a secure and consistent environment, reducing potential software conflicts and improving task reliability.

According to some aspects, the Application Server 130 may utilize secure networking protocols, sandboxing techniques, and/or restricted access controls in the VM instance 132. For example, the environment 100 may utilize one or more virtual private networks (VPNs) and/or firewalls to ensure that only authorized components can communicate during task execution. Moreover, one or more components of the environment 100 may employ encryption for data storage and transmission, safeguarding sensitive information processed by the automated tasks. For example, in scenarios where the automation involves handling financial records or personal data, the automated service framework 110 may encrypt all intermediate and final outputs, ensuring compliance with data protection regulations and enhancing overall security.

Within each VM instance 132, the target software 134 may be deployed to carry out the specified automation tasks. The VM instance 132 may serve as an isolated virtual environment, emulating a typical user's desktop where software interactions occur. For example, by operating within VMs, the automated service framework 110 may provide compatibility across various target software applications without requiring modifications to the underlying cloud infrastructure. Each VM instance may simulate user interactions with the target software 134 through emulated mouse clicks, keyboard inputs, or other graphical interface manipulations.

For example, the target software 134 within the VM instance 132 may perform one or more processing tasks as specified in a request from the user 102. For example, if a document management application is automated, the VM instance 132 may open the application, navigate the UI, and complete tasks such as file manipulation or metadata extraction. Moreover, the automated service framework 110 may leverage the AI operator 136 to recognize and control UI elements in the target software 134, facilitating task completion through simulated user interactions.

The AI operator 136 within each VM instance 132 may act as the automation engine, interpreting user commands and executing interactions with the UI of the target software 134. For example, the AI operator 136 may identify UI components and interact with them as a human user would. Techniques such as OLE, WebDriverIO, and/or AI-based image recognition may allow the AI operator 136 to adapt to different software types. For example, for a web-based target application, the AI operator 136 may utilize WebDriverIO to interact with web elements, while for non-standard software UIs, the AI operator 136 may use image recognition to locate specific UI buttons.

According to some aspects, the AI operator 136 may manage task flow by navigating the target software 134, responding to prompts, and verifying task completion. For example, if a task involves opening and modifying a document, the AI operator 136 may locate the document within the target software 134, apply necessary changes, and save the file. By simulating these interactions programmatically, the AI operator 136 may enable seamless automation of complex tasks, making the automated service framework 110 compatible with applications that traditionally require manual operation.

The AI operator 136 may execute emulated user interactions (e.g., mouse movements, keyboard inputs, or graphical interface manipulations) to mimic manual operations within the target software application. For example, during a document processing task in Adobe Acrobat Pro, the AI operator 136 may simulate mouse clicks to navigate menus, keyboard inputs to fill out fields, and graphical interface manipulations to drag and drop files into appropriate locations. The actions may be dynamically generated based on real-time feedback from the user interface to ensure precision and task accuracy. Moreover, the emulated interactions may utilize AI-powered tools and/or optical character recognition (OCR) and image recognition for interacting with graphical elements. For example, in an industrial application where proprietary interfaces present non-standard graphical components, the AI operator 136 may recognize a specific icon through image recognition and trigger corresponding mouse or keyboard actions. This adaptability may provide compatibility with a wide range of software applications, enhancing the adaptability of the automated service framework 110.

The Database 108 may store configuration data, task logs, and/or automation workflows associated with each target software 134, enabling persistent task management and historical data retrieval. The database 108 may also store metadata related to recognized UI elements, assisting the AI operator 136 in executing interactions accurately. As each task progresses, the associated execution status may be updated in real-time within the database 108 and may be accessible to external systems through the API server 120.

Moreover, the database 108 may support task queuing and prioritization by storing execution histories and associated user configurations, which may enable the Queue Manager 122 within the API server 120 to allocate resources effectively. Additionally, the database 108 may maintain audit logs and task records, providing compliance and traceability for regulated environments. This comprehensive data storage capability may enhance adaptability and accountability of the automated service framework 110, especially in scenarios where maintaining accurate task records and data history is critical.

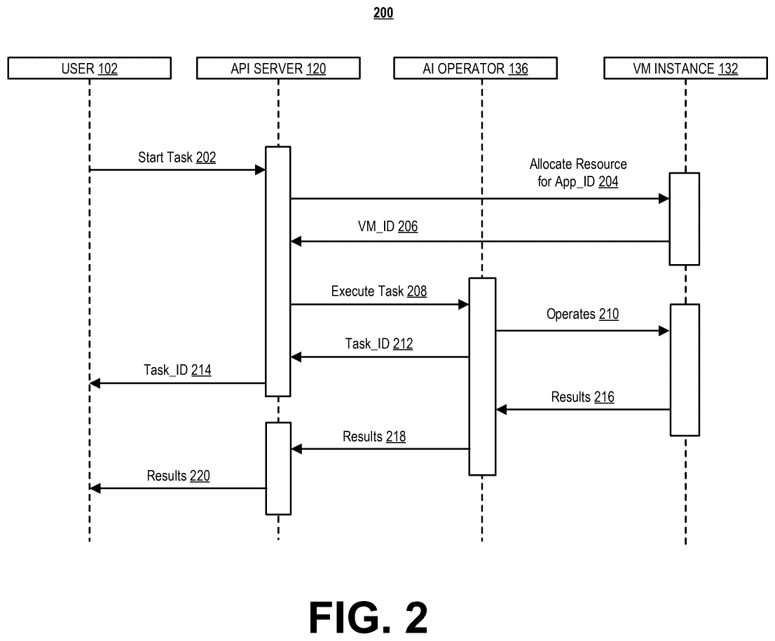

FIG. 2 illustrates an exemplary process 200 for performing automation tasks within a virtual machine (VM) environment as part of the automated service framework 110 for cloud environments. The process 200 may enable task automation by simulating user interactions with software applications that are challenging to automate due to lack of API-level access or specialized system requirements. The process 200 may include steps from task initiation to results transmission, involving the user 102, the API server 120, the AI operator 136, and the VM instance 132.

At step 202, the user 102 may initiate the process 200 by sending a task request to the API server 120. The task request may include the automation needs, such as the type of task to be executed, specific software actions required, and/or other configurations. Upon receiving the request, the API server 120 may act as the central controller, coordinating resource allocation and managing task execution. The API server 120 may parse and prioritize user requests based on pre-defined parameters or urgency levels. For instance, the API server 120 may prioritize document processing tasks over batch operations for faster response times, particularly in high-demand scenarios. Examples of pre-defined parameters or urgency levels that may be parsed by the API server 120 to prioritize user requests may include task criticality (e.g., high-priority document processing), processing deadlines (e.g., same-day completion), resource intensity (e.g., CPU or memory requirements), and/or user-defined priority settings that escalate essential tasks over routine operations.

At step 204, the API server 120 may allocate the necessary resources by initiating a VM instance 132 and associating the VM instance 132 with an application identifier. The application identifier may uniquely designate the target software application within the virtual environment. The application identifier may be utilized for accessing and interacting with the correct application. Moreover, the process 200 may leverage one or more virtual machine orchestration tools to configure the VM instance 132 and install any required software dependencies dynamically. For example, in scenarios where multiple user requests require Adobe Acrobat Pro functionalities, separate VM instances may be created for each request to maintain operational independence and avoid performance bottlenecks.

In step 206, the VM instance 132 may determine a VM identifier, which may uniquely identify the VM instance 132 within the framework, and the VM instance 132 may transmit the VM identifier to the API server 120. The VM identifier may provide a reference for the progression of the task and may be used to track the task throughout the automation process. By linking the VM identifier with the application identifier, the API server 120 may provide route the task and avoid conflicts across multiple parallel tasks. For example, when handling multiple instances of similar tasks (e.g., document processing), the process 200 may use the VM identifier and/or the application identifier to streamline communications and accurately manage task-specific configurations.

At step 208, the API server 120 may instruct the AI operator 136 to execute the designated automation task within the VM instance 132. The API server 120 may issue a command by interfacing with the API endpoints of the AI operator 136. The AI operator 136 may interpret and translate the command into specific actions. The AI operator 136 may recognize and interact with one or more user interface (UI) elements of the target software application. For example, for applications with standard Windows-based UIs, the AI operator 136 may use OLE (Object Linking and Embedding) to access and control UI components. In another example, for web-based applications, WebDriverIO may be utilized to recognize and interact with web elements by parsing HTML DOM structures.

At step 210, the AI operator 136 may perform one or more operations within the VM instance 132. For example, the process 200 may simulate user interactions required to complete the specified task, such as clicking buttons, entering data, or extracting information. The AI operator 136 may dynamically adjust the simulated user interactions based on real-time feedback from the software interface, ensuring high precision and accuracy. In cases where the UI of the target software does not provide standard input elements, the process 200 may use OCR and/or YOLO-based image recognition to identify and interact with graphical components associated with the UI of the target software. For instance, in an industrial control application without conventional UI buttons, the AI operator may use YOLO to identify command icons and OCR to interpret any status information displayed within the software interface.

At step 212, upon completing the task, the AI operator 136 may generate a task identifier to represent the specific task instance and may transmit the task identifier to the API server 120. The task identifier may aid in tracking the task status and correlating it with the initial user request. The task identifier may be used to supports task management by allowing the system to monitor the completion status and/or to troubleshoot in case of errors. For example, in regulated environments requiring task traceability, the task identifier may be logged for compliance audits.

The application server 130 may continuously monitor resource consumption within the VM instance 132 to provide optimal performance during task execution. Metrics such as CPU usage, memory allocation, and/or disk I/O may be tracked in real time to detect and prevent potential resource bottlenecks. For example, if a document processing task requires intensive computation, the application server 130 may dynamically allocate additional virtual resources to maintain efficient operation. Moreover, resource monitoring may provide insights into task scalability and/or identify opportunities for optimization. For example, if a pattern of excessive memory usage is detected during certain automation tasks, the system may provide recommendations for adjustments to the task configuration or resource allocation to enhance efficiency and prevent system overloads.

In step 214, the API server 120 may relay the task identifier back to the user 102, confirming that the task has been initiated and is in progress. Step 214 may enable real-time feedback, allowing the user 102 to monitor the status of their automation requests and anticipate completion times. Moreover, the API server 120 may provide one or more estimated time-to-completion or offer options to adjust task parameters. For example, the user 102 may receive a notification of expected completion time, e.g., with options to prioritize urgent tasks or defer lower-priority operations as needed.

At step 216, the VM instance 132 may transmit (e.g., once the automation task is complete) the task results or status to the AI operator 136. The VM instance 132 may generate raw data files, execution logs, and/or structured outputs based on the task requirements. For example, if the task involves processing a batch of scanned documents, the VM instance may return OCR-processed text data. Moreover, the data may be structured by the AI operator 136 before further processing to ensure accurate output format and completeness.

At step 218, the AI operator 136 may transmit the processed task results to the API server 120. For example, the AI operator 136 may package and/or format data to align with the request of the user 102 and/or system requirements. For example, in document processing tasks, the AI operator 136 may convert the data into standardized formats, such as JSON or XML, to ensure compatibility with downstream systems.

The AI operator 136 may validate the results against pre-set criteria, such as data integrity checks, before transmitting them to avoid incomplete or erroneous outputs. Moreover, the AI operator 136 may validate task completion by comparing the actual results of automation tasks with expected outcomes. For example, if an automation task includes generating a summary document, the process 200 may analyze the produced document for specific markers, such as metadata tags or summary headers, to confirm successful execution. Furthermore, this validation process may use predefined validation criteria stored in a database, ensuring consistency and accuracy across tasks. The process 200 may log discrepancies between expected and actual results for diagnostic purposes. For example, if a task to compile and save a report fails due to file format incompatibility, the process 200 may record the error and provide detailed feedback to the user, enabling prompt resolution. This validation mechanism may enhance reliability and ensure the quality of the automated processes.

At step 220, the API server 120 may transmit the results to the user 102. For example, the API server 120 may deliver the results over a secure communication channel. According to some aspects, the results may include metadata, such as task duration or performance statistics. For example, in document analysis tasks, the results may include metadata detailing the text extracted, processing time, and/or any detected anomalies. Moreover, the user 102 may review, archive, or further process the automation output, e.g., based on feedback associated with execution of the task execution.

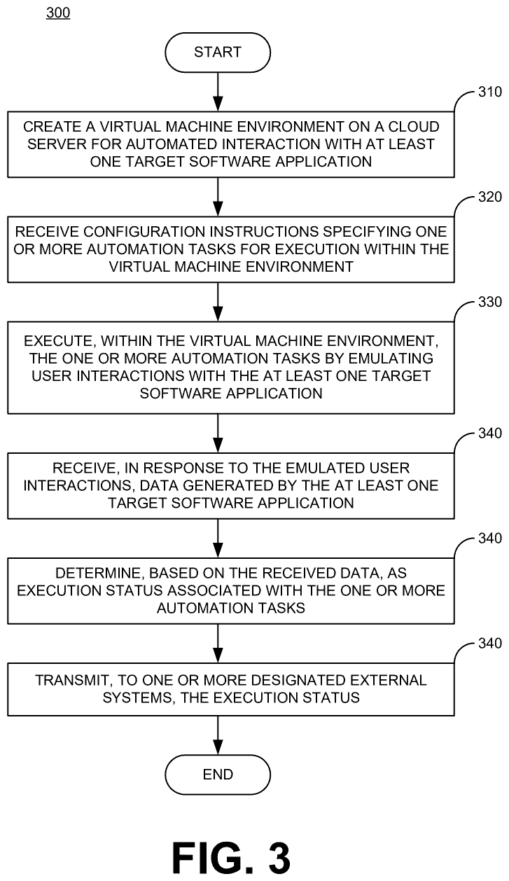

Referring now to FIG. 3, illustrated is a flowchart of a process 300, according to one example of the disclosed systems and processes. The process 300 may perform non-intrusive automation of target software applications through simulated interactions with their user interfaces.

At box 310, the process 300 may include creating a virtual machine environment on a cloud server for automated interaction with at least one target software application. The cloud server may allocate the necessary computing resources to establish an independent VM instance, ensuring the target software application operates within a controlled and isolated environment. For example, if the target application is Adobe Acrobat Pro, the framework may configure the VM instance to emulate a standard desktop environment. The cloud server may load any essential dependencies such as Windows OLE (Object Linking and Embedding) for managing UI control. Thereby the application may be prepared for automated tasks without requiring any modifications to the original software code. Moreover, the VM instance may integrate the image recognition or other control modules to enable the automation framework to simulate user interactions effectively.

At step 320, the VM environment may receive configuration instructions. The configuration instructions may specify the automation tasks to be executed. According to some aspects, the configuration instructions may include parameters such as the sequence of actions to perform, any relevant data inputs, and/or conditional triggers based on expected responses from the application. For example, a configuration may instruct the VM to open Adobe Acrobat, navigate to a specific document location, apply digital signatures, and save the document with a particular naming convention. Moreover, the configuration instructions may be transmitted from an API server, which may act as a central command hub. By embedding operational workflows, the process 300 may optimize each VM instance to handle complex, software-specific interactions and process multiple automation requests simultaneously across distributed instances, thereby enhancing the system's scalability and load management.

At step 330, the process 300 may execute the specified automation tasks within the VM by emulating user interactions with a user interface of the target software application. The emulation may include one or more control methods, such as using Windows OLE for traditional applications, WebDriverIO for web-based interfaces, and/or AI-powered image recognition for software with non-standard UI elements. For example, to automate form submissions in a desktop application, the process 300 may initiate appropriate mouse clicks and/or keyboard inputs to fill out fields, navigate menus, and/or submit forms. For example, in cases where the target application lacks a conventional API, OCR (Optical Character Recognition) and Yolo AI image recognition tools may be used to detect and interact with buttons, icons, and/or text fields rendered on the screen. This flexibility may allow the automation framework to adapt dynamically to diverse application environments and UI configurations, enabling consistent, non-intrusive task execution.

At step 340, process 300 may receive data generated by the target application as a result of the simulated user interactions. The data may include processed files, transaction records, and/or confirmation messages, depending on the nature of the automated task. For example, if the task involves converting a document to PDF format, the generated output file may be captured and stored within a file system (e.g., associated with the VM) for further processing. According to some aspects, OCR may be used to interpret on-screen feedback, such as success notifications or error messages. The on-screen feedback may be used to guide subsequent actions or error-handling routines. The process 300 may monitor and verify the successful completion of each automation task based on the received data, allowing for adaptive responses based on the real-time status of the application.

At step 350, the process 300 may include determining an execution status based on the received data. The process 300 may evaluate various factors such as task completion, encountered errors, and/or the presence of specific success indicators to establish whether the automation task concluded successfully or requires additional handling. For example, if an operation fails due to an invalid data input or application crash, error-handling protocol may initiate corrective actions, such as restarting the application or adjusting input parameters. The execution status may be updated and logged within a database, enabling administrators to review task histories and/or identify potential areas for optimization or troubleshooting.

Moreover, one or more alerts may be initiated if the execution status indicates a failure in completing the automation tasks. One or more alerts may be transmitted to designated users or external systems through various communication channels, such as email, SMS, or webhooks. For example, if a file conversion task fails due to an unsupported format, the process 300 may notify an administrator, providing details of the error and/or recommend corrective actions. Alerts may include logs and diagnostic information to facilitate troubleshooting. For example, in a scenario where a web application fails to respond during an automation task, the process 300 may capture network logs and interface screenshots, sending them along with the alert to support timely issue resolution.

At step 360, the execution status and any generated outputs may be transmitted to designated external systems. The API server may manage the transmission, including packaging the execution status, output data, and/or relevant metadata, such as timestamps or performance metrics, into a standardized format (e.g., JSON or XML). The data transfer may occur over a secure communication channel to ensure compliance with data security protocols, such as when handling sensitive or regulated information. By providing asynchronous notifications, the process 300 may enable seamless integration with external systems that rely on real-time task completion updates, such as enterprise resource planning (ERP) systems or document management platforms. Accordingly, the automation framework may complete tasks and deliver actionable insights to external systems, enhancing operational transparency and facilitating decision-making based on up-to-date task status data.

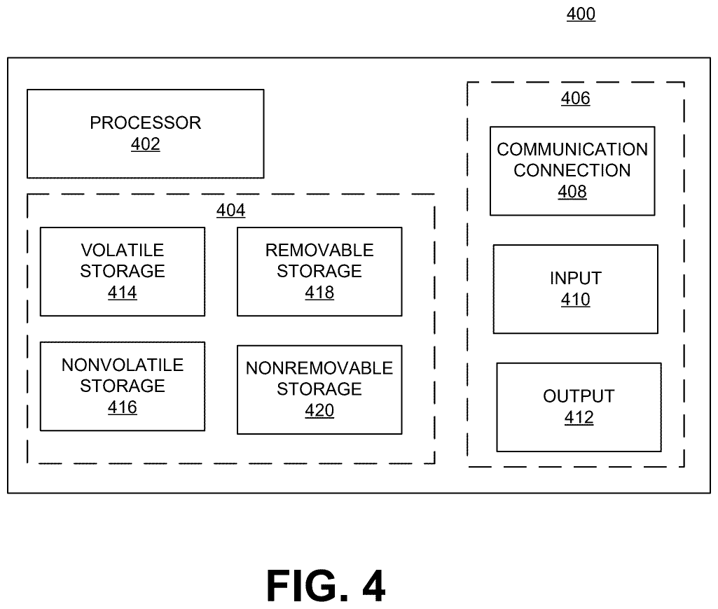

FIG. 4 is a block diagram of a computing device 400 that may be connected to or comprise a component of environment 100. Computing device 400 may comprise hardware or a combination of hardware and software. The functionality to automate software applications (e.g., that lack direct API-level access) may reside in one or a combination of computing devices 400. Computing device 400 depicted in FIG. 4 may represent or perform functionality of an appropriate computing device 400, or a combination of computing devices 400, such as, for example, a component or various components of an automated service framework for cloud environments, a computing device, a processor, a server, a gateway, a database, a firewall, a router, a switch, a modem, an encryption tool, a virtual private network (VPN), a network access control (NAC) device, a secure web gateway, or the like, or any appropriate combination thereof. It is emphasized that the block diagram depicted in FIG. 4 is exemplary and not intended to imply a limitation to a specific example or configuration. Thus, computing device 400 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Computing device 400 may comprise a processor 402 and a memory 404 coupled to processor 402. Memory 404 may contain executable instructions that, when executed by processor 402, cause processor 402 to effectuate operations associated with an automated service framework. As evident from the description herein, computing device 400 is not to be construed as software per se.

In addition to processor 402 and memory 404, computing device 400 may include an input/output system 406. Processor 402, memory 404, and input/output system 406 may be coupled together (coupling not shown in FIG. 4) to allow communications between them. Each portion of computing device 400 may comprise circuitry for performing functions associated with each respective portion. Thus, each portion may comprise hardware, or a combination of hardware and software. Accordingly, each portion of computing device 400 is not to be construed as software per se. Input/output system 406 may be capable of receiving or providing information from or to a communications device or other network entities configured for automating software applications (e.g., that lack direct API-level access). For example, input/output system 406 may include a wireless communication (e.g., 3G/4G/5G/GPS) card. Input/output system 406 may be capable of receiving or sending video information, audio information, control information, image information, data, or any combination thereof. Input/output system 406 may be capable of transferring information with computing device 400. In various configurations, input/output system 406 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 406 may comprise a Wi-Fi finder, a two-way GPS chipset or equivalent, or the like, or a combination thereof.

Input/output system 406 of computing device 400 also may contain a communication connection 408 that allows computing device 400 to communicate with other devices, network entities, or the like. Communication connection 408 may comprise communication media. Communication media may embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 406 also may include an input device 410 such as keyboard, mouse, pen, voice input device, or touch input device. Input/output system 406 may also include an output device 412, such as a display, speakers, or a printer.

Processor 402 may be capable of performing functions associated with an automated service framework for cloud environments, such as functions for automating software applications (e.g., that lack direct API-level access), as described herein. For example, processor 402 may be capable of, in conjunction with any other portion of computing device 400, automating interactions with specialized target software applications, as described herein.

Memory 404 of computing device 400 may comprise a storage medium having a concrete, tangible, physical structure. As is known, a signal does not have a concrete, tangible, physical structure. Memory 404, as well as any computer-readable storage medium described herein, is not to be construed as a signal. Memory 404, as well as any computer-readable storage medium described herein, is not to be construed as a transient signal. Memory 404, as well as any computer-readable storage medium described herein, is not to be construed as a propagating signal. Memory 404, as well as any computer-readable storage medium described herein, is to be construed as an article of manufacture.

Memory 404 may store any information utilized in conjunction with automating software applications (e.g., that lack direct API-level access). Depending upon the exact configuration or type of processor, memory 404 may include a volatile storage 414 (such as some types of RAM), a nonvolatile storage 416 (such as ROM, flash memory), or a combination thereof. Memory 404 may include additional storage (e.g., a removable storage 418 or a non-removable storage 420) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by computing device 400. Memory 404 may comprise executable instructions that, when executed by processor 402, cause processor 402 to effectuate operations associated with automating software applications (e.g., that lack direct API-level access).

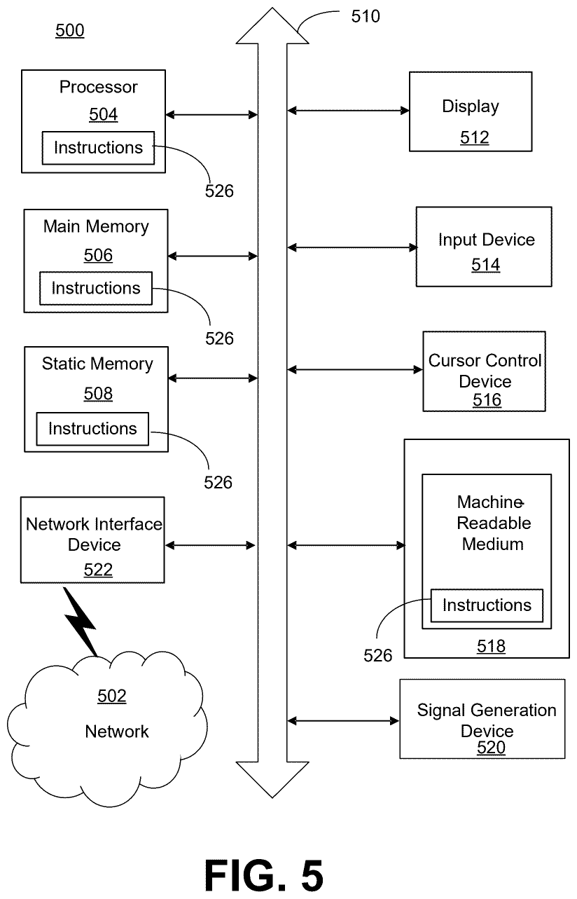

FIG. 5 depicts an exemplary diagrammatic representation of a machine in the form of a computer system 500 within which a set of instructions, when executed, may cause the machine to perform any one or more of the methods described above. One or more instances of the machine can operate, for example, as processor 402, computing device(s) 104, automated service framework 110, database 108, and other devices of FIGS. 1-4. In some examples, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid-state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the examples described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium on which is stored one or more sets of instructions (e.g., instructions 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

While examples of a system for automating software applications (e.g., that lack direct API-level access) have been described in connection with various computing devices/processors, the underlying concepts may be applied to any computing device, processor, or system capable of automating interactions with specialized target software applications. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer readable storage medium is not a propagating signal. A computer-readable storage medium as described herein is an article of manufacture. When the program code is loaded into and executed by a machine, such as a computer, the machine becomes a device for automating software applications (e.g., that lack direct API-level access). In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language and may be combined with hardware implementations.

The methods and devices associated with automating interactions with specialized target software applications as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an erasable programmable read-only memory (EPROM), a gate array, a programmable logic device (PLD), a client computer, or the like, the machine becomes a device for automating interactions with specialized target software applications as described herein. When implemented on a general-purpose processor, the program code combines with the processor to provide a unique device that operates to invoke the functionality of automating software applications (e.g., that lack direct API-level access).

While the disclosed systems have been described in connection with the various examples of the various figures, it is to be understood that other similar implementations may be used, or modifications and additions may be made to the described examples of an automated service framework without deviating therefrom. For example, one skilled in the art will recognize that an automated service framework as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—automating software applications—as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein.

What is claimed:

1. One or more computing devices, comprising one or more processors, configured to:
create a virtual machine environment on a cloud server for automated interaction with at least one target software application;
receive configuration instructions specifying one or more automation tasks for execution within the virtual machine environment;
execute, within the virtual machine environment, the one or more automation tasks by emulating user interactions with the at least one target software application;
receive, in response to the emulated user interactions, data generated by the at least one target software application;
determine, based on the received data, as execution status associated with the one or more automation tasks; and
transmit, to one or more designated external systems, the execution status.

2. The one or more computing devices of claim 1, wherein the automated interaction with the at least one target software application is independent of application programming interface (API)-level access.

3. The one or more computing devices of claim 1, wherein the at least one target software application does not provide application programming interface (API)-level access.

4. The one or more computing devices of claim 1, wherein the emulated user interactions comprise one or more of mouse movements, keyboard inputs, or graphical interface manipulations.

5. The one or more computing devices of claim 1, wherein receiving the data generated by the at least one target software application comprises one or more of capturing screen data, retrieving processed data, or extracting task completion indicators.

6. The one or more computing devices of claim 1, further configured to store the execution status in a centralized task management database accessible to an external interface.

7. The one or more computing devices of claim 1, wherein the execution status is transmitted upon a successful completion of the one or more automation tasks.

8. The one or more computing devices of claim 1, wherein the execution status is transmitted to an administrator and the execution status comprises a requirement of user intervention.

9. The one or more computing devices of claim 1, further configured to dynamically adjust the emulated user interactions based on real-time feedback from the target software application.

10. The one or more computing devices of claim 1, further configured to validate completion of each of the one or more automation tasks based on a comparison with one or more expected task results.

11. The one or more computing devices of claim 1, further configured to prioritize the one or more automation tasks based one or more of an urgency level, a user-defined priority level, or an availability of a resource within the virtual machine environment.

12. The one or more computing devices of claim 1, further configured to monitor resource consumption within the virtual machine environment during the execution of the one or more automation tasks.

13. The one or more computing devices of claim 1, wherein the configuration instructions comprise one or more scheduling parameters associated with a timing and a frequency of the one or more automation tasks within the virtual machine environment.

14. The one or more computing devices of claim 1, further configured to encrypt data transmissions between the virtual machine environment and the one or more designated external systems.

15. The one or more computing devices of claim 1, further configured to initiate an alert if the execution status indicates a failure in completing the one or more automation tasks.

16. The one or more computing devices of claim 1, wherein the configuration instructions comprise a sequence associated with an order of execution of the one or more automation tasks.

17. The one or more computing devices of claim 1, wherein the one or more automation tasks are executed in parallel within separate virtual machine environments on the cloud server.

18. The one or more computing devices of claim 1, further configured to establish an isolated environment within the virtual machine environment, wherein the isolated environment is associated with preventing an unauthorized access during execution of the one or more automation tasks.

19. A method performed by one or more computing devices, the method comprising:
creating a virtual machine environment on a cloud server for automated interaction with at least one target software application;
receiving configuration instructions specifying one or more automation tasks for execution within the virtual machine environment;
executing, within the virtual machine environment, the one or more automation tasks by emulating user interactions with the at least one target software application;
receiving, in response to the emulated user interactions, data generated by the at least one target software application;
determining, based on the received data, as execution status associated with the one or more automation tasks; and
transmitting, to one or more designated external systems, the execution status.

20. A system comprising:
one or more processors; and
memory coupled with the one or more processors, the memory storing executable instructions that when executed by the one or more processors cause the one or more processors to effectuate operations comprising:
creating a virtual machine environment on a cloud server for automated interaction with at least one target software application;
receiving configuration instructions specifying one or more automation tasks for execution within the virtual machine environment;
executing, within the virtual machine environment, the one or more automation tasks by emulating user interactions with the at least one target software application;
receiving, in response to the emulated user interactions, data generated by the at least one target software application;
determining, based on the received data, as execution status associated with the one or more automation tasks; and
transmitting, to one or more designated external systems, the execution status.
